(19) United States
(12) Patent Application Publication
(10) Pub. No.: US 2020/0196786 A1
(43) Pub. Date: Jun. 25, 2020

(54) EDIBLE UTENSIL FOR THE CONSUMPTION OF LIQUID FOOD

(71) Applicant: Christian Zippel, Neutraubling (DE)

(72) Inventor: Christian Zippel, Neutraubling (DE)

(21) Appl. No.: 16/719,221

(22) Filed: Dec. 18, 2019

(30) Foreign Application Priority Data
Dec. 20, 2018 (DE) 202018107352.4

(51) Int. Cl. A47G 21/18; A23L 7/109

(52) U.S. Cl. CPC A47G 21/183; A23V 2002/00; A23L 7/109

(57) ABSTRACT

An edible utensil is provided for the consumption of liquid food, this edible utensil having a hollow, substantially tubular body with a first end, a second end opposite the first end, an outer surface that is substantially hose-like in form and an inner surface that is formed substantially coaxially with the outer surface and forms a food flow channel, characterised in that the dimensions of the tubular body are such that the edible utensil can be used as a drinking straw for the intake of liquid food through the food flow channel, the tubular body being made of a pasta dough or pasta-dough-based material and being subjected to a thermochemical treatment that results in it being possible to consume the edible utensil like an easily digestible pasta product both during the intake of the liquid food and after the intake of the liquid food.

### TECHNICAL FIELD

The present disclosure describes an edible utensil for the consumption of liquid food. In particular, the present disclosure relates to an edible utensil in the form of a straw.

### BACKGROUND

Edible utensils for the consumption of liquid food are known. These known edible utensils are of limited functionality and complex in structure.

There is a need to provide improved edible utensils.

### SUMMARY

The present disclosure proposes a novel edible utensil for the consumption of liquid food. The edible utensil comprises a hollow, substantially tubular body having a first end, a second end opposite the first end, an outer surface that is substantially hose-like or cylindrical in form in and an inner surface that is formed substantially coaxially with the outer surface and defines a flow channel or food flow channel.

The dimensions of the tubular body are such that the edible utensil can be used as a drinking straw for the intake of liquid food through the food flow channel.

The tubular body is made of a pasta dough or pasta-dough-based material and is subjected to a thermo-chemical treatment that results in it being possible to consume the edible utensil like an easily digestible pasta product both during the intake of liquid food and after the intake of liquid food.

The term liquid food is understood to include viscous foods that can, in principle, be eaten through a drinking straw. By thermochemically treating the tubular body with oil, it is possible, in particular, to condition of the tubular body in an appropriate or desired manner such that the tubular body is neither too hard for consumption nor too soft for consumption or to be used as a drinking straw.

The thermochemical treatment of the hollow, substantially tubular body comprises oiling, or applying an oil or an oleaginous substance to, the hollow, substantially tubular body. When oil is applied to the hollow, substantially tubular body, this oil is able to work into the pasta-dough-based material, thereby making it possible to influence the elastic properties of the pasta-dough-based material and the hollow, substantially tubular body.

Applying oil to the hollow, substantially tubular body may involve applying oil to the outer surface of the hollow, substantially tubular body, in particular coating the outer surface of the hollow, substantially tubular body in oil. The outer surface of the hollow, substantially tubular body can be coated in oil simply by using an oil brush, for example. Coating the hollow, substantially tubular body with an oil brush allows the oil to be applied in finely dosed quantities in order to achieve the desired conditioning of the edible utensil.

Applying oil to the hollow, substantially tubular body may comprise at least partially dipping or immersing the hollow, substantially tubular body in oil. Dipping or immersing the hollow, substantially tubular body in oil is particularly suitable for the mass production of the edible utensil in that it allows oil to be applied to a plurality of hollow, substantially tubular bodies at the same time. In this process the oil is able to enter the food flow channel via the first or the second end of the hollow, tubular body such that the inner surface of the hollow, substantially tubular body is also exposed to the oil, thereby making it possible to achieve higher elasticity of the tubular body.

The oil may be mixed with at least one aromatic, flavouring and/or colouring agent. By adding aromatic, flavouring and/or colouring agents, it is possible to provide the user with a multiplicity of experiences using the edible utensil. Alternatively, or in addition, the pasta dough or pasta-dough-based material can be mixed with at least one aromatic, flavouring and/or colouring agent.

The thermochemical treatment of the hollow, substantially tubular body may comprise baking the hollow, substantially tubular body, in particular in a baking oven. Baking, in particular after the application of oil, may lend the hollow, substantially tubular body a pleasant crispiness. By using a baking process it is possible to guarantee the substantially even thermal treatment of the tubular body.

The baking process makes it possible to accelerate the effect of the oil on the pasta-dough-based material thereby giving the hollow, substantially tubular body an optimal elastic-crispy condition.

The edible utensil may have a functional extension in particular at the first end and/or at the second end of the tubular body. In particular, the first end and/or the second end may be shaped like a handle, a ladle or a shovel.

In some embodiments the edible utensil has a flattened end such that the edible utensil can be used both as a drinking straw and as a spoon. A functional extension of this kind means that the edible utensil can be used in many different ways.

The functional extension may, in particular, be achieved by shaping or deforming the substantially tubular body, in particular after oiling and/or during or after baking.

The functional extension may also take the form of an attachment that can be subsequently placed on the hollow, substantially tubular body.

The hollow, substantially tubular body may take the form of a piece of raw macaroni, in particular a piece of commercially available macaroni. Raw macaroni is generally already of a suitable shape and size for use as a straw or drinking straw. In addition, raw, commercially available macaroni is readily available. By using raw macaroni as the basis for the production of the hollow, substantially tubular body it is possible to produce the edible utensil simply and at no great cost.

Also proposed is a method for the production of an edible utensil comprising:
the provision of a hollow, substantially tubular body made of a pasta dough or pasta-dough-based material,
the chemical treatment, in particular the oiling of the hollow, substantially tubular body, an oil or oleaginous liquid being applied to the hollow, substantially tubular body, and
the thermal treatment of the oiled tubular body, this type of conditioning of the hollow, tubular body enabling the edible utensil to be consumed like an easily digestible pasta product both during and after the intake of liquid food.

The provision of the hollow, substantially tubular body may, in particular, comprise the provision of a piece of raw macaroni. Raw macaroni is already of suitable size and shape to be used as a straw or drinking straw. In addition, raw macaroni can be obtained without difficulty from both food stores and wholesalers. Another type of pasta other than macaroni may also be used, for example a type designed specifically to produce an application- or customer-specific utensil.

Oiling may, in particular, comprise applying a coating of oil or a coating containing the oleaginous substance to the outer surface of the tubular body. The outer surface may, in particular, be oiled by coating the outer surface using an oil brush. Coating the hollow, substantially tubular body using an oil brush makes it possible to apply the oil in finely dosed quantities and thus to condition the edible utensil in a specific, desired manner.

Oiling may also be carried out by dipping or immersing the tubular body in an oil bath. In this process the oil or oleaginous substance is able to enter the flow channel or food flow channel via the first end and/or the second end of the hollow, tubular body such that the inner surface of the hollow, substantially tubular body is also exposed to the oil or oleaginous substance, thus making it possible to achieve a high level of elasticity of the tubular body.

The oil used may, in particular, be a vegetable cooking oil such as sunflower oil, rapeseed oil, olive oil, etc. In some embodiments the chemical treatment involves the application of the oil or oleaginous substance to the hollow, substantially tubular body for a predetermined time, in particular for 5 to 25 minutes, at a predetermined temperature, in particular at room temperature (approx. 20°).

The thermal treatment may, in particular, comprise baking the oiled body, in particular in a baking oven.

In some embodiments the method involves the provision of a functional extension for the edible utensil. The functional extension may, in particular, involve the shaping of the first end and/or the second end of the hollow, tubular body. In particular, the first end and/or the second end may be shaped as a handle or ladle and/or as a shovel or spoon.

In some embodiments the functional extension is provided in the form of an attachment or by placing an attachment on the first end or the second end of the tubular body.

Also provided in the present disclosure is a functional extension of a piece of macaroni in the form of an attachment to be placed on one of the ends of the piece of macaroni.

### BRIEF DESCRIPTION OF THE DRAWINGS

The invention will now be explained in greater detail with reference to the attached drawings. In the figures parts that are identical or have the same effect are designated by identical reference numerals.

FIG. 1 shows a schematic, perspective view of an edible utensil according to one embodiment.

FIG. 2 shows a schematic cross section through an edible utensil according to one embodiment.

FIG. 3 shows a perspective view of an edible utensil according to a further embodiment.

FIG. 4 shows a flow diagram of a method for the production of an edible utensil according to an example.

### DETAILED DESCRIPTION

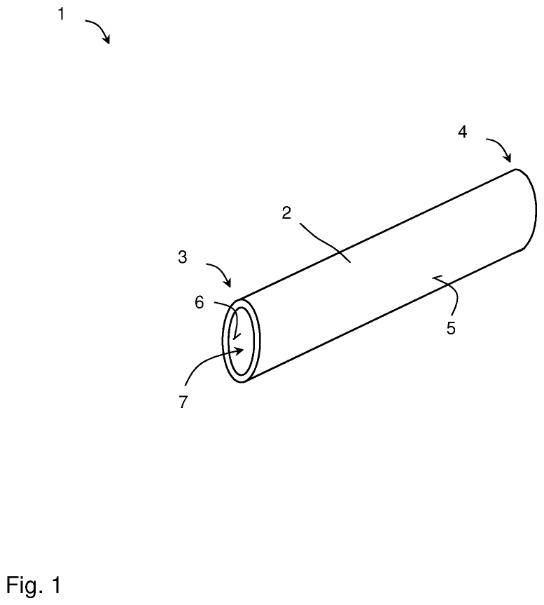

FIG. 1 shows a schematic perspective view of an edible utensil according to one embodiment. The edible utensil 1 has a hollow, substantially tubular body 2 with a first end 3 and a second end 4 opposite the first end 3. The tubular body 2 has an outer surface 5 that substantially cylindrical in form and an inner surface 6 that is formed substantially coaxially with the outer surface 5, the inner surface 6 of the tubular body 2 defining a flow channel 7 or food flow channel.

In the embodiment shown in FIG. 1, the tubular body 2 has a length L of approx. 20 cm, an external diameter D of approx. 1.5 cm and an internal diameter d of approx. 0.8 cm. Depending on the embodiment, the length L, external diameter D and internal diameter d may vary with the following intervals: 5 cm<L<25 cm, 0.5 cm<D<2 cm and 0.3 cm<d<1.5 cm.

The tubular body 2 is made of a pasta-dough-based material. In particular, in the embodiment shown in FIG. 1, the tubular body is made substantially of a pasta dough, the pasta dough having been exposed to a thermochemical treatment.

Due to the dimensions of the tubular body 2 the edible utensil 1 can be used as a drinking straw or straw for the intake of liquid food if the liquid food is located in an open container such as a glass, for example. To take in liquid food, the first end 3 or the second end 4 of the tubular body 2 is dipped into the liquid food to be consumed while the mouth sucks on the other or free end 4 or 3 of the tubular body to produce an under-pressure inside the flow channel. The under-pressure inside the flow channel leads to an increase in the level of the liquid food inside the flow channel, allowing the liquid food to be conveyed from the container into the user's mouth.

If the container is emptied, the utensil can be consumed, in particular completely consumed. The edible utensil can also be at least partially consumed before or during the intake of liquid food. Due to its easy digestibility, the utensil can therefore serve as a welcome addition to the liquid food. In some embodiments the utensil contains at least one aromatic, flavouring and/or colouring agent. It is possible to offer a multiplicity of experiences with the edible utensil by using aromatic, flavouring and/or colouring agents.

In some embodiments the edible utensil 1 is provided based on a piece of macaroni. In particular, a piece of raw macaroni is provided and subjected to a thermochemical treatment that results in it being possible to consume the edible utensil like an easily digestible pasta production both during the intake of the liquid food and after the intake of the liquid food.

In some embodiments the thermochemical treatment comprises applying an oil or oleaginous liquid to the hollow, tubular body, after which the tubular body undergoes an oven step. In this oven step the oiled tubular body is placed in a baking over for a period of 10 to 30 minutes at a temperature of 50 to 200° C., preferably 180° C.

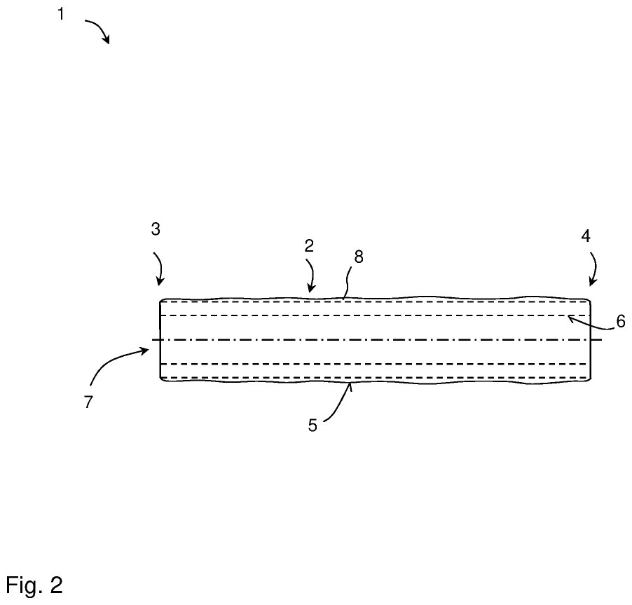

FIG. 2 shows a schematic cross section through an edible utensil according to one embodiment. The schematic representation in FIG. 2 shows, in particular, the flow channel 7 and an oil coating 8 on the outer surface 5 of the tubular body.

In the embodiment shown the oil coating 8 is present on the outer surface 5 only. The oil layer 8 may also, in particular additionally, be provided on the inner surface 6 and on the transverse surfaces 6 at the first end 3 and/or the second end 4 of the tubular body that connect the outer surface 5 to the inner surface 6.

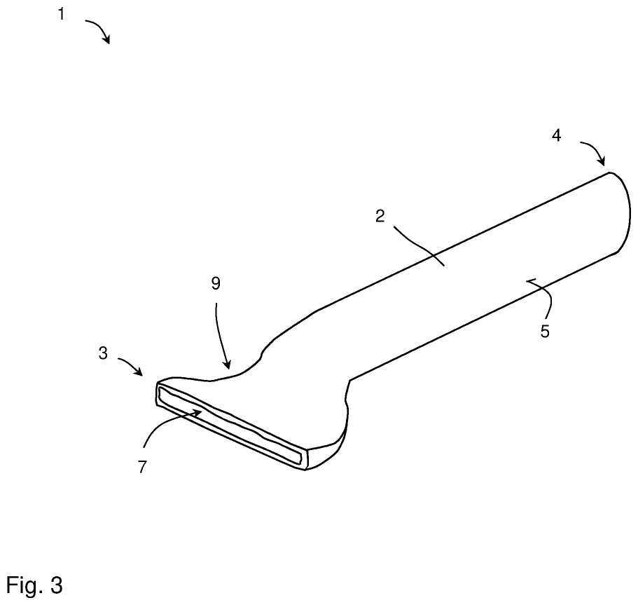

FIG. 3 shows a perspective view of an edible utensil according to a further embodiment. The edible utensil 1 shown in FIG. 3 is substantially similar to the embodiments of the edible utensil shown in FIGS. 1 and 2. In contrast to the embodiments shown in FIGS. 1 and 2, the edible utensil in FIG. 3 has on the first end 3 a functional extension 9 that is designed in this embodiment as a flattening of the hollow, substantially tubular body. This flattened section of the hollow, substantially tubular body extends the functionality of the edible utensil in that the edible utensil can also be used as a spoon. This can be advantageous particularly if the edible utensil is used to consume viscous foods, e.g. soft ice cream or smoothies.

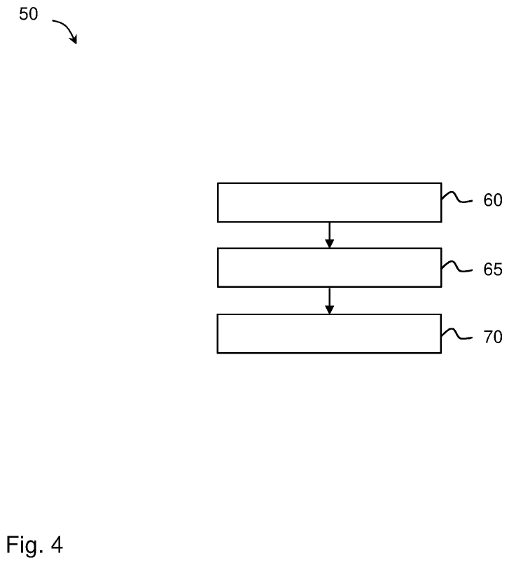

FIG. 4 shows a flow diagram of a method for the production of an edible utensil according to an example.

According to the method 50 shown in FIG. 4, in a first step 60 a hollow, substantially tubular body 2 made of a pasta-dough-based material is provided. Step 60 may, in particular, involve the provision of a piece of raw macaroni. Raw macaroni is generally already of suitable size and shape to be used as a straw or drinking straw. In addition, raw macaroni is readily available from both food stores and wholesalers. Another type of pasta other than macaroni may also be used, for example a type designed specifically to produce an application- or customer-specific utensil.

In a subsequent step 65 the hollow, substantially tubular body 2 is subjected to a chemical treatment. The chemical treatment may, in particular, comprise oiling, or applying an oil or an oleaginous substance to, the tubular body 2. Oiling or applying oil to the hollow, substantially tubular body 2 may, in particular, comprise applying a coating of oil or the oleaginous substance to the outer surface 5 of the tubular body 2. Oiling the outer surface 5 may, in particular, be carried out by coating the outer surface 6 using an oil brush.

In some embodiments the tubular body is dipped in an oil bath.

The oil used may, in particular, be a vegetable cooking oil such as sunflower oil, rapeseed oil, olive oil, etc. In some embodiments the chemical treatment comprises applying the oil or oleaginous substance to the hollow, substantially tubular body for a predetermined time, in particular for 5 to 25 minutes, at a predetermined temperature, in particular at room temperature (approx. 20°).

In a subsequent step 70 the oiled tubular body is subjected to a thermal treatment. The thermal treatment may, in particular, involve baking the oiled body 2, in particular in a baking oven.

In some embodiments the first end 3 and/or the second end 4 of the tubular body has a functional extension.

The functional extension may involve the shaping of the first end 3 and/or the second end.

In particular, the first end 3 and/or the second end 4 may be shaped as a handle or ladle and/or as a shovel or spoon.

In some embodiments the functional extension takes the form of an additional part or attachment that can be placed on the first end 3 or the second end 4 of the tubular body. According to one aspect, a piece of macaroni is provided with a functional extension designed as an attachment on an end of a piece of macaroni.

Although at least one exemplary embodiment is illustrated in the description above, various changes and modifications may be made. The embodiments cited are simply examples and are not intended to limit the scope of application, the applicability or the configuration of the present disclosure in any way. Indeed, the description given above is intended to provide the person skilled in the art with a plan for implementing at least one exemplary embodiment, it being possible to make numerous changes to the function and arrangement of the elements described in the exemplary embodiment without leaving the scope of protection of the attached claims and their legal equivalents.

### KEY TO REFERENCE NUMERALS

1 Edible utensil

2 Hollow, substantially tubular body

3 First end

4 Second end

5 Outer surface

6 Inner surface

7 Flow channel

8 Coating

9 Functional extension

50 Method

60 Provision of a tubular body

65 Chemical treatment

70 Thermal treatment

1. An edible utensil for the consumption of liquid food, the edible utensil comprising a hollow, substantially tubular body with a first end, a second end opposite the first end, an outer surface that is substantially hose-like in form and an inner surface that is formed substantially coaxially with the outer surface and forms a food flow channel, characterised in that
the dimensions of the tubular body are such that the edible utensil is configured to be used as a drinking straw for the intake of a liquid food through the food flow channel, the tubular body being made of a pasta dough or pasta-dough-based material and being subjected to a thermochemical treatment such that the edible utensil is configured to be consumed like an easily digestible pasta product both during the intake of the liquid food and after the intake of the liquid food.

2. An edible utensil according to claim 1, wherein the thermochemical treatment comprises the application of an oil to the hollow, substantially tubular body.

3. An edible utensil according to claim 2, wherein applying the oil to the hollow, substantially tubular body comprises applying the oil to the outer surface of the hollow, substantially tubular body and coating the outer surface of the hollow, substantially tubular body with the oil.

4. An edible utensil according to claim 2, wherein applying the oil to the hollow, substantially tubular body comprises at least partially dipping or immersing the hollow, substantially tubular body in oil.

5. An edible utensil according to claim 2, wherein at least one aromatic, flavouring or colouring agent is added to the oil.

6. An edible utensil according claim 1, wherein the thermochemical treatment of the hollow, substantially tubular body comprises baking the hollow, substantially tubular body.

7. An edible utensil according claim 1, wherein the edible utensil comprises a functional extension at the first end or at the second end of the tubular body.

8. An edible utensil according to claim 7, wherein the functional extension comprises shaping the hollow tubular body.

9. An edible utensil according to claim 7, wherein the functional extension takes the form of an attachment on the hollow, substantially tubular body.

10. An edible utensil according to claim 1, wherein the hollow, substantially tubular body is made of a piece of macaroni.

11. A method of manufacturing an edible utensil, the method comprising:
forming a hollow tubular body from a pasta dough or pasta-dough-based material, the tubular body defining a first end,
a second end opposite from the first end, and outer surface that is substantially hose-like in form, and an inner surface that is formed substantially coaxially with the outer surface and forms a food flow channel, the tubular body configured to be used as a drinking straw for the intake of a liquid food through the food flow channel;
subjecting the tubular body to a thermochemical treatment to configure the edible utensil to be consumed like an easily digestible pasta product both during the intake of the liquid food and after the intake of the liquid food.

12. The method of claim 11, wherein subjecting the tubular body to the thermochemical treatment comprises applying an oil to the tubular body.

13. The method of claim 12, wherein applying the oil to the tubular body comprises applying the oil to the outer surface of the tubular body and coating the outer surface of the tubular body with the oil.

14. The method of claim 12, wherein applying the oil to the tubular body comprises at least partially dipping or immersing the tubular body in oil.

15. The method of claim 12, wherein at least one aromatic flavouring or colouring is added to the oil.

16. The method of claim 11, wherein subjecting the tubular body to the thermochemical treatment comprises baking the tubular body.

17. The method of claim 11, the method further comprising forming a functional extension at the first end or the second end of the tubular body.

18. The method of claim 17, wherein forming the functional extension comprises shaping the hollow tubular body.

19. The method of claim 17, wherein forming the functional extension comprises attaching the functional extension to the tubular body.

20. The method of claim 11, wherein forming the tubular body comprises forming the tubular body from a piece of macaroni.
